(19) United States
(12) Patent Application Publication
(10) Pub. No.: US 2004/0027075 A1
(43) Pub. Date: Feb. 12, 2004

(54) High pressure mercury lamp and lamp unit

(76) Inventors: Shinichiro Hataoka, Osaka (JP); Kiyoshi Takahashi, Kyoto (JP); Makoto Horiuchi, Nara (JP); Makoto Kai, Osaka (JP); Tsuyoshi Ichibakase, Osaka (JP); Tomoyuki Seki, Osaka (JP); Yuriko Kaneko, Nara (JP)

Correspondence Address: HARNESS, DICKEY & PIERCE, P.L.C., P.O. BOX 828, BLOOMFIELD HILLS, MI, 48303, US

(21) Appl. No.: 10/606,500

(22) Filed: Jun. 26, 2003

(30) Foreign Application Priority Data
Jun. 26, 2002 (JP) 2002-186503

(51) Int. Cl. H01J 13/32

(52) U.S. Cl. 315/115

(57) ABSTRACT

A high pressure mercury lamp includes a luminous bulb in which at least mercury is enclosed inside the bulb, and a pair of sealing portions that retain airtightness of the luminous bulb. The amount of the enclosed mercury is 230 mg/cm³ or more based on a volume of the luminous bulb, and heating means for heating the luminous bulb is provided at least at part of the luminous bulb and the pair of sealing portions.

### BACKGROUND OF THE INVENTION

The present invention relates to a high pressure mercury lamp and a lamp unit. In particular, the present invention relates to a high pressure mercury lamp enclosing a comparatively large amount of mercury among high pressure mercury lamps used as a light source of projectors or the like.

In recent years, as a system realizing a large scale screen images, image projecting apparatuses such as liquid crystal projectors or DMD projectors have been widely used. As such an image projecting apparatus, a high pressure mercury lamp as disclosed in Japanese Laid-Open Patent Publication No. 2-148561 is commonly used in a wide range.

FIG. 1 shows the structure of the high pressure mercury lamp disclosed in Japanese Laid-Open Patent Publication No. 2-148561. A lamp 1000 shown in FIG. 1 includes a luminous bulb 1 mainly made of quartz glass, and a pair of side tube portions (sealing portions) 2 extending from both ends thereof Metal electrode structures are buried in the side tube portions 2 so that power can be supplied to the luminous bulb from the outside. The electrode structure has a structure in which an electrode 3 made of tungsten (W), a molybdenum (Mo) foil 4, and an external lead wire 5 are electrically connected sequentially in this order. A coil 12 is wound around the head of the electrode 3. In the luminous bulb 1, mercury (Hg), which is a luminous species, argon (Ar) and a small amount of halogen gas (not shown) are enclosed.

The operational principle of the lamp 1000 will be described. When a start voltage is applied to both ends of the pair of external lead wires 5, discharge of Ar occurs, and the temperature in the luminous bulb 1 increases. With this increase of the temperature, Hg atoms evaporate and fill the luminous bulb 1 in the form of gas. The Hg atoms are excited by electrons released from one electrode 3 and become luminous between the two electrodes 3. Therefore, as the vapor pressure of Hg, which is the luminous species, is higher, light having a higher intensity is released. Furthermore, as the vapor pressure of Hg is higher, the potential difference (voltage) between the two electrodes is larger, so that current can be reduced when the lamp is operated with the same rated power. This means that a burden to the electrode 3 can be reduced, which leads to a longer lifetime of the lamp. Therefore, as the Hg vapor pressure is larger, a lamp having better characteristics in terms of the intensity and the lifetime can be obtained.

However, in view of the physical strength against pressure, a conventional high pressure mercury lamp is operated at a Hg vapor pressure of about 15 to 20 MPa (150 to 200 atm) in a practical use. Japanese Laid-Open Patent Publication No. 2-148561 discloses a superhigh pressure mercury lamp used at a Hg vapor pressure of 200 bar to 350 bar (equivalent to about 20 MPa to about 35 MPa), but in a realistic use in view of the reliability and the lifetime or the like, the lamp is used at a Hg vapor pressure of about 15 MPa to 20 MPa (150 to 200 atm).

Although research and development are performed to increase the strength against pressure, a high pressure mercury lamp that can withstand a high pressure such as a Hg vapor of more than 20 MPa in practical use has not been reported yet at present. In this context, the inventors of the present invention succeeded in completing a high pressure mercury lamp that can withstand high pressure such as a Hg vapor of about 30 to 40 MPa or more (about 300 to 400 atm or more) and disclosed Patent Applications Nos. 2001-267487 and 2001-371365.

This high pressure mercury lamp having a very high withstand pressure is operated at a high mercury vapor pressure that cannot be achieved in the conventional technique, and therefore the characteristics and the behavior cannot be predicted. When the inventors of the present invention made operation tests of the high pressure mercury lamp, it was found that the lamp is blackened when the operating pressure exceeds 20 MPa, which is the conventional operating pressure, especially reaches generally 30 MPa or more.

### SUMMARY OF THE INVENTION

Therefore, with the foregoing in mind, it is a main object of the present invention to provide a high pressure mercury lamp that is not blackened even at an operating pressure of more than 20 MPa (e.g., 23 MPa or more, particularly 25 MPa or 30 MPa or more).

A high pressure mercury lamp of the present invention includes a luminous bulb in which at least mercury is enclosed inside the bulb, and a pair of sealing portions that retain airtightness of the luminous bulb. At least one of the sealing portions has a first glass portion extending from the luminous bulb and a second glass portion provided in at least a portion inside the first glass portion, and the one of the sealing portions has a portion to which a compressive stress is applied. Furthermore, a heating wire is provided at least at part of the luminous bulb and the pair of sealing portions.

It is preferable that the amount of the enclosed mercury is 230 mg/cm³ or more based on the volume of the luminous bulb.

In one preferable embodiment, the amount of the enclosed mercury is 300 mg/cm³ or more based on the volume of the luminous bulb, halogen is enclosed in the luminous bulb, the bulb wall load of the high pressure mercury lamp is 80 W/cm² or more, and the heating wire is means for heating the luminous bulb.

The heating wire may be wound around at least one of the sealing portions.

In one preferable embodiment, external lead wires are extending from end portions of the pair of sealing portions, and one end of the heating wire is electrically connected to at least one of the external lead wires.

A switch for turning on and off an electrical connection with the external lead wire is provided in a portion of the heating wire. The heating wire is electrically connected to the external lead wire before operation, and after operation, the electrical connection with the external lead wire is disconnected, and the heating wire is electrically connected to a power source for supplying current to the heating wire.

In one preferable embodiment, a switch for disconnecting an electrical connection with the external lead wire is provided in a portion of the heating wire.

In one preferable embodiment, a pair of electrode rods are opposed to each other in the luminous bulb, at least one of the pair of electrode rods is connected to a metal foil, and the metal foil is provided in the sealing portion, and at least a portion of the metal foil is positioned in the second glass portion.

In one preferable embodiment, a coil having at least one metal selected from the group consisting of Pt, Ir, Rh, Ru, and Re at least on its surface is wound around at least in a portion of the electrode rod that is buried in the at least one of the sealing portions.

In one preferable embodiment, a metal portion that is in contact with the second glass portion and supplies power is provided in the sealing portions, the compressive stress is applied at least in the longitudinal direction of the sealing portions, the first glass portion contains 99 wt % or more of SiO₂, and the second glass portion contains SiO₂ and at least one of 15 wt % or less of Al₂O₃ and 4 wt % or less of B.

Another high pressure mercury lamp of the present invention includes a luminous bulb in which at least mercury is enclosed inside the bulb and a pair of electrode rods are opposed, and a pair of sealing portions extending from the luminous bulb. A coil having at least one metal selected from the group consisting of Pt, Ir, Rh, Ru, and Re at least on its surface is wound around at least in a portion of the electrode rod that is buried in at least one of the sealing portions, and a heating wire is provided at least at part of the luminous bulb and the pair of sealing portions.

Yet another high pressure mercury lamp of the present invention includes a luminous bulb in which at least mercury is enclosed inside the bulb, and a pair of sealing portions that retain airtightness of the luminous bulb. The amount of the enclosed mercury is 230 mg/cm³ or more based on the volume of the luminous bulb, and heating means for heating the luminous bulb is provided at least at part of the luminous bulb and the pair of sealing portions.

In one preferable embodiment, the heating means is a heating wire, the amount of the enclosed mercury is 300 mg/cm³ or more based on the volume of the luminous bulb, halogen is enclosed in the luminous bulb, and the bulb wall load of the high pressure mercury lamp is 80 W/cm² or more.

The high pressure mercury lamp may further include means for measuring the temperature of the luminous bulb.

In one preferable embodiment, the means for measuring the temperature is a thermocouple.

In one preferable embodiment, the heating means is configured so as to heat the luminous bulb at the same time as operation is started or after operation is started.

A high pressure mercury lamp in an embodiment includes a luminous bulb in which a pair of electrodes are opposed in the bulb, and sealing portions extending from the luminous bulb and having a portion of the electrode inside. A metal film constituted by at least one metal selected from the group consisting of Pt, Ir, Rh, Ru, and Re is formed on a surface at least in a portion of the electrode that is positioned inside the sealing portions.

In one embodiment, the electrodes are connected to the metal foils provided in the sealing portions by welding, and the metal film is not formed in the connection portion with the metal foils and is formed on the surface of the electrodes that is buried in the sealing portions. A portion of the metal constituting the metal film may be present in the luminous bulb. It is preferable that the metal film has a multilayered structure including an Au layer as the lower layer and a Pt layer as the upper layer.

A high pressure mercury lamp in an embodiment includes a luminous bulb in which a pair of electrodes are opposed in the bulb, and a pair of sealing portions extending from the luminous bulb and having a portion of the electrode inside. A coil having at least one metal selected from the group consisting of Pt, Ir, Rh, Ru, and Re on its surface is wound around a portion of the electrode that is positioned inside the sealing portions. In one embodiment, the metal foil and a portion of the electrode are buried in the sealing portions, and a coil having at least one metal selected from the group consisting of Pt, Ir, Rh, Ru, and Re on its surface is wound around the electrode that is buried in the sealing portions. It is preferable that the coil has a metal film having a multilayered structure including an Au layer as the lower layer and a Pt layer as the upper layer on its surface.

A high pressure mercury lamp in one embodiment includes a luminous bulb enclosing a luminous substance inside; and sealing portions for retaining airtightness of the luminous bulb. The sealing portion has a first glass portion extending from the luminous bulb and a second glass portion provided at least in a portion inside the first glass portion. The sealing portion has a portion to which a compressive stress is applied. The portion to which a compressive stress is applied is one selected from the group consisting of the second glass portion, a boundary portion of the second glass portion and the first glass portion, a portion of the second glass portion on the side of the first glass portion, and a portion of the first glass portion on the side of the second glass portion. In one embodiment, a strain boundary region caused by a difference in the compressive stress between the first glass portion and the second glass portion is present in the vicinity of the boundary of the two glass portions. It is preferable that a metal portion for supplying power that is in contact with the second glass portion is provided in the sealing portion. The compressive stress may be applied at least in the longitudinal direction of the sealing portion.

In one embodiment, the first glass portion contains 99 wt % or more of SiO₂, and the second glass portion contains SiO₂ and at least one of 15 wt % or less of Al₂O₃ and 4 wt % or less of B. The softening point of the second glass portion is lower than that of the first glass portion. It is preferable that the second glass portion is formed of a glass tube. It is preferable that the second glass portion is not formed by compressing and sintering glass powder. In one embodiment, the compressive stress in the portion to which the compressive stress is applied is about 10 kgf/cm² or more and about 50 kgf/cm² or less, or the difference in the compressive stress is about 10 kgf/cm² or more and about 50 kgf/cm² or less.

In one embodiment, a pair of electrode rods are opposed in the luminous bulb, at least one of the pair of electrode rods is connected to a metal foil, and the metal foil is provided in the sealing portion, and at least a portion of the metal foil is positioned in the second glass portion. At least mercury is enclosed in the luminous bulb as the luminous substance, and the amount of the mercury enclosed is 300 mg/cc or more. The general color rendering index Ra of the high pressure mercury lamp is more than 65. It is preferable that the color temperature of the high pressure mercury lamp is 8000 K or more.

A lamp unit of the present invention includes a high pressure mercury lamp and a reflecting mirror for reflecting light emitted from the high pressure mercury lamp. The high pressure mercury lamp includes a luminous bulb in which at least mercury is enclosed inside the bulb, and a pair of sealing portions that retain airtightness of the luminous bulb. At least one of the sealing portions has a first glass portion extending from the luminous bulb and a second glass portion provided in at least a portion inside the first glass portion, and the one of the sealing portions has a portion to which a compressive stress is applied, and a heating wire is provided at least at part of the luminous bulb and the pair of sealing portions.

Another lamp unit of the present invention includes a high pressure mercury lamp and a reflecting mirror for reflecting light emitted from the high pressure mercury lamp. The high pressure mercury lamp includes a luminous bulb in which at least mercury is enclosed inside the bulb, and a pair of sealing portions that retain airtightness of the luminous bulb. At least one of the sealing portions has a first glass portion extending from the luminous bulb and a second glass portion provided in at least a portion inside the first glass portion, and the one of the sealing portions has a portion to which a compressive stress is applied, and a heating wire is provided at least at a portion of the reflecting mirror.

It is preferable that the amount of the enclosed mercury is 230 mg/cm³ or more based on the volume of the luminous bulb.

Yet another lamp unit of the present invention includes a high pressure mercury lamp and a reflecting mirror for reflecting light emitted from the high pressure mercury lamp. The high pressure mercury lamp includes a luminous bulb in which at least mercury is enclosed inside the bulb, and a pair of sealing portions that retain airtightness of the luminous bulb. The amount of the enclosed mercury is 230 mg/cm³ or more based on the volume of the luminous bulb, and heating means for heating the luminous bulb is provided at least at part of the luminous bulb and the pair of sealing portions.

In one preferable embodiment, the amount of the enclosed mercury is 300 mg/cm³ or more based on the volume of the luminous bulb, halogen is enclosed in the luminous bulb, and the bulb wall load of the high pressure mercury lamp is 80 W/cm² or more.

In one preferable embodiment, the lamp unit further includes means for measuring the temperature of the luminous bulb.

In one preferable embodiment, the means for measuring the temperature is a thermocouple, and the thermocouple is provided in at least one selected from the group consisting of a portion of the high pressure mercury lamp, a portion of the reflecting mirror and a portion of a lamp system to which the reflecting mirror is to be incorporated.

In one preferable embodiment, the heating means is a heating wire, and the heating wire serves as a trigger wire.

### BRIEF DESCRIPTION OF THE DRAWINGS

FIG. 1 is a schematic view showing the structure of the conventional high pressure mercury lamp 1000.

FIGS. 2A and 2B are schematic views showing the structure of a high pressure mercury lamp 1100.

FIG. 3 is a schematic view showing the structure of a high pressure mercury lamp 1200.

FIG. 4 is a schematic view showing the structure of a high pressure mercury lamp 1300.

FIG. 5A is a schematic view showing the structure of a high pressure mercury lamp 1400 and FIG. 5B is a schematic view showing the structure of a high pressure mercury lamp 1500.

FIG. 6A is a schematic view showing the structure of a high pressure mercury lamp 100 and FIG. 6B is a schematic view showing the structure of a high pressure mercury lamp 200 of an embodiment of the present invention.

FIG. 7 is a schematic view showing the structure of an operating system of the lamp 200 of an embodiment of the present invention.

FIG. 8 is a graph showing the optical spectrum of lamps having operating pressures of 20 MPa and 40 MPa.

FIG. 9 is a schematic view of a lamp for illustrating the temperature distribution of a luminous bulb during operation.

FIG. 10 is a graph showing the temperature measurement results of the lamps 100 and 200.

FIG. 11 is a graph showing a change of operating power over time of the lamps 100 and 200.

FIG. 12 is a graph showing a change of operating current over time of the lamps 100 and 200.

FIG. 13 is a variation example of the lamp 200 of an embodiment of the present invention.

FIG. 14 is a variation example of the lamp 200 of an embodiment of the present invention.

FIG. 15 is a schematic view showing the structure of a lamp unit in which a mirror is incorporated with the lamp 200.

FIG. 16 is a schematic view showing the structure of a lamp unit in which a mirror is incorporated with the lamp 200.

FIG. 17 is a schematic view showing the structure of an operating system having means for measuring the temperature of the lamp 200.

FIG. 18 is a schematic view showing the structure of an operating system having a start-aid function for the lamp 200.

### DETAILED DESCRIPTION OF THE INVENTION

First, before describing embodiments of the present invention, a high pressure mercury lamp that can withstand a very high pressure such as an operating pressure of about 30 to 40 MPa or more (about 300 to 400 atm or more) will be described. The details of such a high pressure mercury lamp are disclosed in Patent Application Nos. 2001-267487 and 2001-371365, which are incorporated herein by reference.

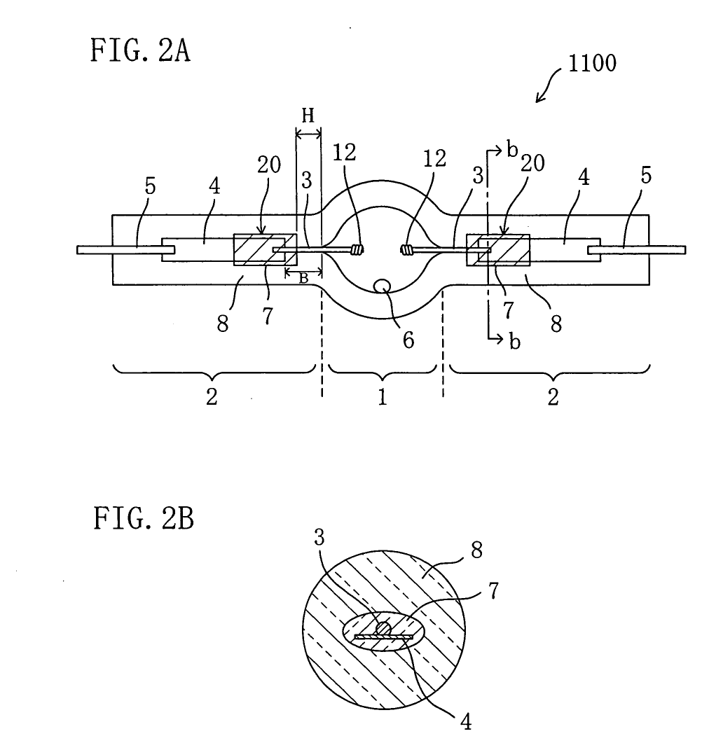

It was very difficult to develop a high pressure mercury lamp that can withstand an operating pressure of about 30 MPa or more in practical use, but for example, with the structure shown in FIG. 2, a lamp having a very high withstand pressure was completed successfully. FIG. 2B is a cross-sectional view taken along line b-b in FIG. 2A.

The high pressure mercury lamp 1100 shown in FIG. 2 is disclosed in Patent Application No. 2001-371365, and includes a luminous bulb 1 and a pair of sealing portions 2 for retaining the airtightness of the luminous bulb 1. At least one of the sealing portions 2 has a first glass portion 8 extending from the luminous bulb 1 and a second glass portion 7 provided in at least a portion inside of the first glass portion 8, and the one sealing portion 2 has a portion (20) in which a compression stress is applied.

The first glass portion 8 in the sealing portion 2 contains at least 99 wt % of SiO₂, and is made of quartz glass, for example. On the other hand, the second glass portion 7 contains SiO₂ and at least one of 15 wt % or less of Al₂O₃ and 4 wt % or less of B, and is made of Vycor glass, for example. When Al₂O₃ or B is added to SiO₂, the softening point of the glass is decreased, so that the softening point of the second glass portion 7 is lower than that of the first glass portion 8. It should be noted that Vycor glass (product name) is glass that has better processability than that of quartz glass by mixing an additive to quartz glass so as to decrease the softening point. The composition thereof is, for example, 96.5 wt % of silica (SiO₂), 0.5 wt % of alumina (Al₂O₃) and 3 wt % of boron (B). In this embodiment, the second portion 7 is formed of a glass tube made of Vycor glass. Instead of the glass tube made of Vycor glass, a glass tube containing 62 wt % of SiO₂, 13.8 wt % of Al₂O₃ and 23.7 wt % of CuO can be used.

It is sufficient that the compression stress applied into a portion of the sealing portion 2 is substantially more than 0 (that is, 0 kgf/cm²). The presence of this compression stress can improve the strength against pressure over a conventional structure. It is preferable that the compression stress is about 10 kgf/cm² or more (about 9.8×10⁵ N/m² or more) and about 50 kgf/cm² or less (about 4.9×10⁶ N/m² or less). When it is less than 10 kgf/cm², the compression strain may be weak so that the strength against pressure of the lamp may not be increased sufficiently. The reason why the compression stress is preferably less than 50 kgf/cm² is that there is no practical glass material to realize a structure having a compression stress of more than 50 kgf/cm². However, even if the compression stress is less than 10 kgf/cm², if it substantially exceeds 0, the withstand pressure can be higher than that of the conventional structure. In addition, if a practical material that can realize a structure having a compression stress of more than 50 kgf/cm² is developed, the second glass portion 7 can have a compression stress of more than 50 kgf/cm².

An electrode rod 3 whose one end is positioned in the discharge space is connected to a metal foil 4 provided in the sealing portion 2 by welding, and at least a portion of the metal foil 4 is positioned in the second glass portion 7. In the structure shown in FIG. 2, a portion including the connection portion of the electrode rod 3 and the metal foil 4 is covered with the second glass portion 7. The size of the second glass portion 7 in the structure shown in FIG. 2 is, for example, as follows: the length in the longitudinal direction of the sealing portion 2 is about 2 to 20 mm (e.g., 3 mm, 5 mm or 7 mm), and the thickness of the second glass portion 7 sandwiched between the first glass portion 8 and the metal foil 4 is about 0.01 to 2 mm (e.g., 0.1 mm). The distance H which is from the end face of the second glass portion 7 on the luminous bulb 1 side to the discharge space of the luminous bulb 1 is, for example, 0 mm to about 3 mm. The distance B which is from the end face of the metal foil 4 on the luminous bulb 1 side to the discharge space of the luminous bulb 1 (in other words, the length in which the electrode rod 3 alone is buried in the sealing portion 2) is, for example, about 3 mm.

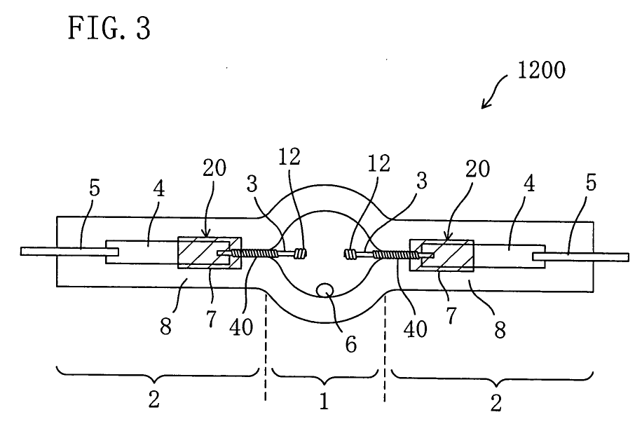

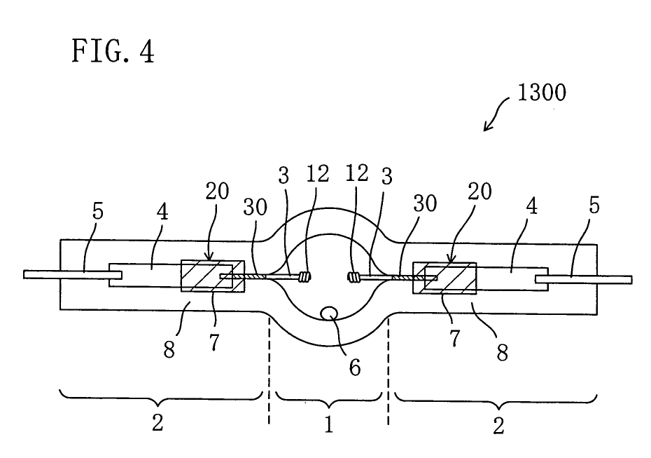

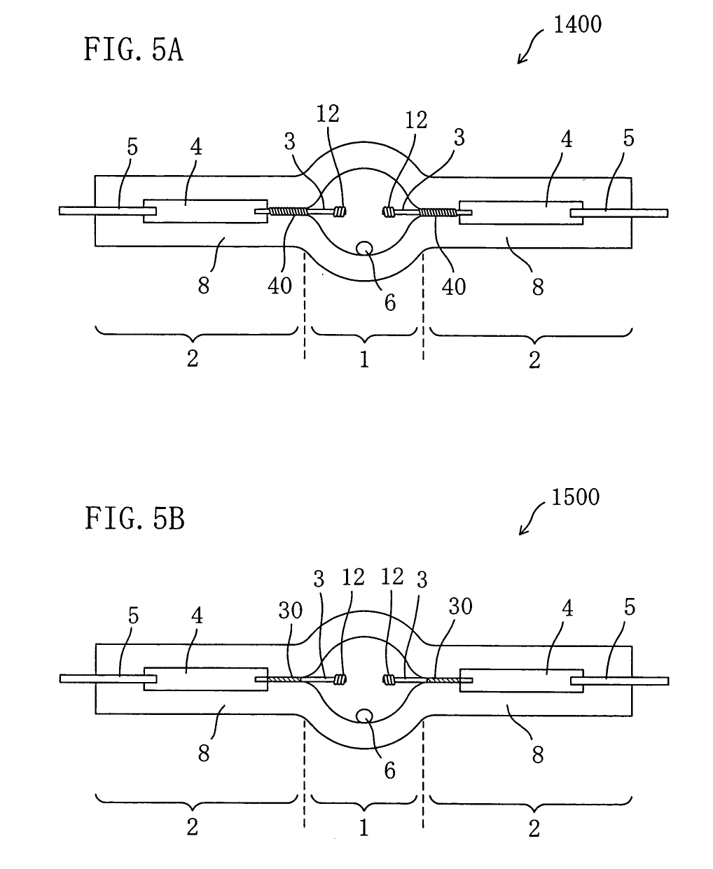

The lamp 1100 shown in FIG. 2 can be modified as shown in FIG. 3. A high pressure mercury lamp 1200 shown in FIG. 3 has a structure in which a coil 40 having a metal of at least one selected from the group consisting of Pt, Ir, Rh, Ru, and Re on its surface is wound around the portion of the electrode 3 that is positioned in the sealing portion 2. In this embodiment, the coil 40 typically has a metal film having a multilayered structure of an Au layer as the lower layer and a Pt layer as the upper layer on its surface. Instead of the coil 40, a metal film 30 formed of at least one selected from the group consisting of Pt, Ir, Rh, Ru, and Re is formed on the surface of at least a portion of the electrode 3 that is positioned in the sealing portion 2, as shown in the high pressure mercury lamp 1300 shown in FIG. 4, which may be somewhat a disadvantage in production process in mass production. High pressure mercury lamps 1400 and 1500 having structures employing the coil 40 or the metal film 30 without using the second glass portion 7, as shown in FIGS. 5A and 5B, can realize an operating pressure of 30 MPa or more in the level in which the lamp can operate in practical use, although the withstand pressure becomes lower than that of the structures shown in FIGS. 2 to 4.

A lamp in which the Hg vapor pressure during operation exceeds 30 MPa (300 atm) as shown in FIG. 2 was produced as a sample and the inventors of the present invention made operation tests. Then, it was found that when the operating pressure reaches about 30 MPa or more, the lamp is blackened. Blackening is a phenomenon that occurs when the temperature of the W electrode 3 is increased during operation and W (tungsten) evaporated from the W electrode is attached onto the inner wall of the luminous bulb, and if the lamp constitutes to be operated, it will be broken.

Here, if the lamp is operated at a conventional operating pressure of about 15 to 20 MPa (150 to 200 atm), a halogen gas enclosed in the luminous bulb reacts with tungsten attached onto the inner wall of the luminous bulb to be converted into tungsten halide. The tungsten halide floats in the luminous bulb and reaches the head of the W electrode having a high temperature, the tungsten halide is dissociated into halogen and tungsten, which is the original state, so that the tungsten returns to the head of the electrode. This is referred to as “halogen cycle”. At the Hg vapor pressure of the conventional lamp, the lamp can be operated without being blackened because of this cycle. However, the experiments of the inventors of the present invention confirmed that when the operating pressure is 30 MPa (300 atm) or more, this cycle does not work well. Even if blackening becomes significant at 30 MPa or more, in order to increase the reliability in practical use, it is necessary to take measures against the blackening problem, not only in the level of 30 MPa or more, but also in the level of more than 20 MPa (e.g., the level of 23 MPa or more, or 25 MPa or more).

The inventors of the present invention found that the blackening problem can be solved by controlling the temperature of the luminous bulb 1, and achieved the present invention. Hereinafter, embodiments of the present invention will be described. However, the present invention is not limited to the following embodiments.

Embodiment 1

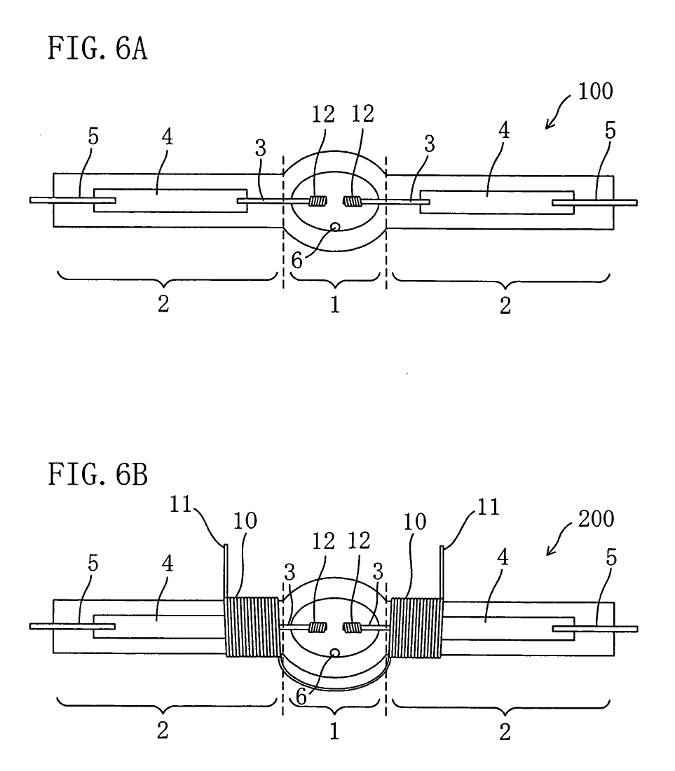

Hereinafter, embodiments of the present invention will be described with reference to the accompanying drawings. FIG. 6A shows a high pressure mercury lamp 100 having an amount of enclosed mercury 6 of 230 mg/cm³ or more. The high pressure mercury lamp 100 is typically the high pressure mercury lamps 1100 to 1500 shown in FIGS. 2 to 5A and 5B.

As in the structures shown in FIG. 2 and the like, the high pressure mercury lamp 100 shown in FIG. 6A includes a luminous bulb 1 enclosing at least mercury 6 inside and a pair of sealing portions 2 for retaining the airtightness of the luminous bulb 1. The amount of the enclosed mercury 6 is 230 mg/cm³ or more (e.g., 250 mg/cm³ or more or 300 mg/cm³ or more, and more than 350 mg/cm³ or 350 mg/cm³ to 400 mg/cm³ or more in some cases) based on the volume of the luminous bulb 1.

In the luminous bulb 1, a pair of electrodes (or electrode rods) 3 are opposed to each other, and the electrodes 3 are connected to metal foils 4 by welding. The metal foils 4 are typically molybdenum foils and are provided in the sealing portions 2. When the high pressure mercury lamp 100 is the lamp 1100 shown in FIG. 2, at least a portion of the metal foil 4 is positioned inside the second glass portion 7.

FIG. 6B shows the structure of a high pressure mercury lamp 200 of this embodiment. As shown in FIG. 6B, the high pressure mercury lamp 200 is obtained by providing heating means 10 for heating the luminous bulb 1 at the lamp 100 shown in FIG. 6A. The heating means 10 is a heating wire and is wound around at least a portion of the luminous bulb 1 and the pair of sealing portions 2. In this embodiment, the heating wire 10 is wound around the sealing portion 2. More specifically, the heating wire 10 is wound from one of the sealing portions 2 and wound around the other sealing portion 2, straddling the luminous bulb 1. The number of windings is about 30 revolutions. In this embodiment, a kanthal wire, which is hardly oxidized, is used as the heating wire 10.

The structures of the lamps 100 and 200 will be described in detail. The lamp 100 (or 200) includes a luminous bulb 1 made mainly of quartz and a pair of sealing portions (side tube portions) 2 extending from both ends of the luminous bulb and is a double end type lamp having two sealing portions 2. The luminous bulb 1 is substantially spherical, and the outer diameter is, for example, about 5 mm to 20 mm, and the thickness of the glass is, for example, about 1 mm to 5 mm. The volume of the discharge space of the luminous bulb 1 is, for example, about 0.01 cc to 1 cc (0.01 cm³ to 1 cm³). In this embodiment, the luminous bulb 1 having an outer diameter of about 10 mm, a thickness of the glass of about 3 mm, and a volume of the discharge space of the luminous bulb 1 of about 0.06 cc is used.

A pair of electrode rods 3 are opposed in the luminous bulb 1. The heads of the electrode rods 3 are provided in the luminous bulb with a distance (arc length) of about 0.2 to 5 mm. In this embodiment, the arc length is 0.5 to 1.8 mm. The lamp of this embodiment is operated with AC current. The sealing portion 2 has a shrink structure produced by a shrinking approach. In the luminous bulb 1, mercury 6, which is the luminous species, is enclosed in an amount of 300 mg/cc or more. In this embodiment, mercury is enclosed in an amount of 400 mg/cc. A rare gas (e.g., Ar) with 5 to 40 kPa and, if necessary, a small amount of halogen are enclosed. In this embodiment, Ar with 20 kPa is enclosed, and halogen is enclosed in the form of CH₂Br₂ in the luminous bulb. The amount of the enclosed CH₂Br₂ is about 0.0017 to 0.17 mg/cc, which corresponds to about 0.01 to 1 μmol/cc in terms of the halogen atom density during lamp operation. In this embodiment, it is about 0.1 μmol/cc. The bulb wall load applied to the inner wall of the luminous bulb during operation is, for example, 60 W/cm² or more. In this embodiment, the lamp is operated at 120 W and the bulb wall load is about 150 W/cm².

Next, the operation of the lamp 200 and the effect of suppressing blackening will be described.

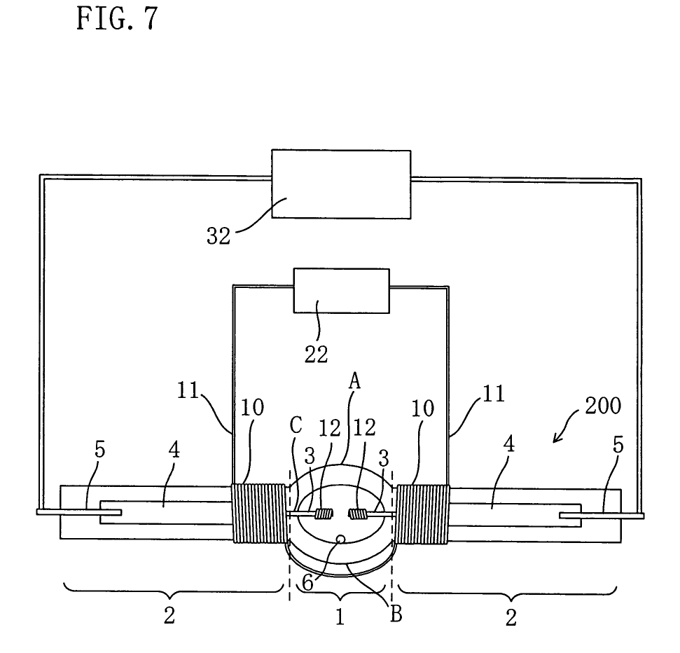

First, as shown in FIG. 7, the lamp 200 is electrically connected to a ballast 32, and the heating wire 10 is electrically connected to a power source unit 22. More specifically, both ends 11 of the heating wire 10 are connected to the power source unit 22, and the ends of the external lead wires 5 are connected to the ballast 32.

Then, the ballast 32 is switched on to operate the lamp 200. Several seconds later, the power source unit 22 is operated to heat the lamp 200. The power source unit 22 can be operated at the same time when the ballast 32 is operated, or can be operated within a few minutes later. The power required to heat the heating wire 10 is suitably about 10 to 50 W In this embodiment, a power of 10 W is supplied.

Ten lamps 100 without the heating wire 10 and ten lamps 200 of this embodiment are operated for several hours. The amount of the enclosed mercury is 350 mg/cc for all the twenty lamps. The lamps 100 without the heating wire 10 are the lamps 1100 shown in FIG. 2 and the lamps 200 are configured simply by winding the heating wire 10 around the lamp 1100.

The lamps 100 were operated by connecting only ballast 32 to both ends of the external lead wires 5. On the other hand, the lamps 200 were connected to the ballast 32 at both the ends of the external lead wires 5, and after the lamps were operated, the power source unit 22 connected to both the ends 11 of the heating wire 10 allowed current to flow through the heating wire 10 so as to increase the temperature of the luminous bulb 1. As a result, the lamps 100 were operated for several hours, and all the lamps are blackened. On the other hand, the lamps 200 continued to be operated without being blackened. This seems to be because the halogen cycle worked well by changing the temperature of the lamps (in particular, the temperature in the luminous bulb 1). This aspect will be described in detail later.

Furthermore, the inventors of the present invention prepared the lamps 100 and 200 having an amount of enclosed mercury of 250, 300, and 350 mg/cc (three lamps for each amount are prepared). These lamps were operated for several hours in the same manner as in the above experiments.

For the lamps 100, all the lamps with 300 mg/cc or more were blackened and broken. However, the lamp having an amount of enclosed mercury of 250 mg/cc were not blackened. On the other hand, with the structure of the lamp 200, all the lamps were operated without being blackened.

The fact that the lamps are blackened at an operating pressure of 30 MPa or more was found by the inventors of the present invention for the first time. This is because there has been no practically usable lamp having an operating pressure of 30 MPa.

The reason why the lamps having an operating pressure of 30 MPa or more are blackened is not definitely clarified at present. Since a definite reason is not known, the inventors of the present invention attempted various measures and modifications to prevent blackening. For example, it was confirmed that in the lamps having an operating pressure of 30 MPa or more, the temperature of the lamp (in particular, the luminous bulb) was increased more than in the lamps with 15 MPa to 20 MPa. Then, the inventors suspected that this increase might be a cause of blackening, and decreased the temperature of the luminous bulb by cooling the luminous bulb during lamp operation. However, blackening was not prevented. They made various other attempts, but blackening was not prevented well. During the experiments, based on the idea that heating the luminous bulb might work well, the temperature of the luminous bulb was increased. Then, to their surprise, they succeeded in preventing blackening. Inferring from this successful example, it seems that blackening is prevented for the following reason.

The lamps having an operating pressure of 30 MPa enclose a larger amount of Hg, which is the luminous species, than that of regular lamps. Therefore, electrons released from the electrodes collide with Hg atoms more often than the lamps having an operating pressure of 20 MPa, and Hg excites in a larger frequency. Furthermore, the electron mobility is decreased so that the arc is narrower than that of the lamps of 20 MPa. As a result, the energy per unit volume of the arc is larger and therefore an arc having a higher intensity and a higher temperature. Therefore, the temperature of the heads of the electrodes is increased, and tungsten evaporates more than that in the lamp of 20 MPa. In addition, there are more Hg ions that are attracted to a cathode and sputter the electrodes, and this effect also increases the amount of tungsten evaporated. In other words, the arc temperature is higher and floating Hg and tungsten are present in a larger amount than those in the lamps of 20 MPa. Therefore, convection occurring in the luminous bulb is larger than that in the lamps of 20 MPa, so that more tungsten is carried onto the inner wall of the luminous bulb.

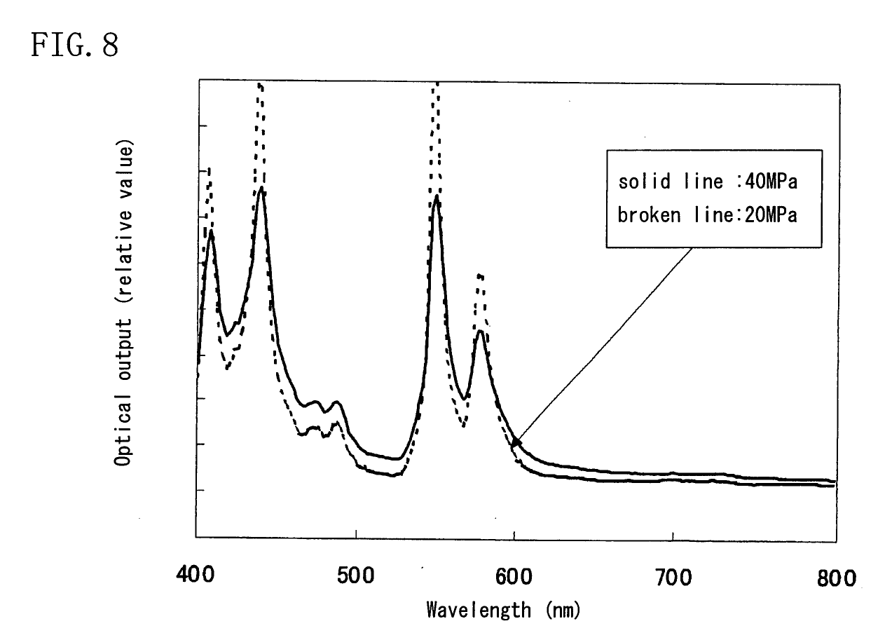

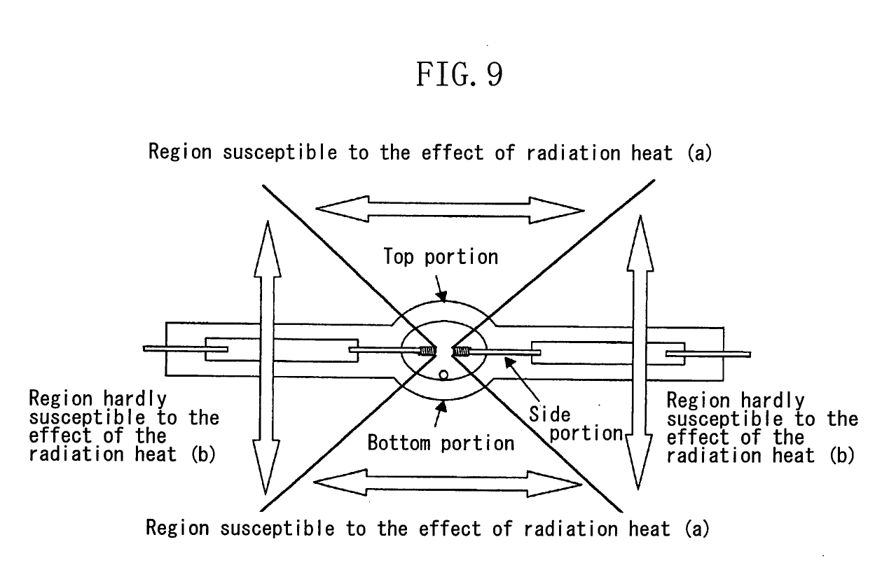

Furthermore, in the lamps having an operating pressure of 30 MPa or more, radiation heat released from the arc is larger than that in the lamps having an operating pressure of 20 MPa, and therefore the thermal balance in the luminous bulb that is maintained in the lamp of 20 MPa collapses. Hereinafter, the collapse of the balance will be described with reference to FIGS. 8 and 9.

FIG. 8 shows the optical spectrum of lamps having an operating pressure of 20 MPa and 40 MPa. As shown in FIG. 8, when the operating pressure is increased, emission of light in the infrared region is increased. Therefore, the radiation heat from the arc is larger when the operating pressure is larger. This is because the temperature difference between the region susceptible to the effect of the radiation heat from the arc ((a) in FIG. 9) and the region hardly susceptible to the effect of the radiation heat ((b) in FIG. 9) is enlarged by the larger radiation heat. As a result, the temperature balance in the luminous bulb that is maintained in the lamp of 20 MPa collapses in the lamp of 30 MPa. Furthermore, a convection in the luminous bulb is larger and heat is carried from the lower portion of the luminous bulb to the upper portion so that the temperature balance also collapses in the upper and the lower portions.

The above-described state is generated in the lamp of 30 MPa, so that the heat balance collapses. Therefore, it is inferred that in the lamp of 30 MPa, the tungsten attached onto the inner wall of the luminous bulb cannot return to the electrodes by the halogen cycle, and blackening occurs.

The inventors of the present invention found that blackening can be prevented by positively controlling the temperature of the luminous bulb 1, and provided the heating means (10) at the lamp. It seems that by positively controlling the temperature of the luminous bulb 1, a reaction W+Br₂→WBr₂ in the inner wall of the luminous bulb was accelerated by a temperature increase, and as a result, W attached onto the inner wall of the luminous bulb succeeded in returning to the electrodes.

In this experiment, the lamps of 30 MPa or more are blackened, but in order to guarantee that blackening does not occur for a long time with respect to lamps of 30 MPa or less, but more than 20 MPa (i.e., lamps having an operating pressure exceeding the conventional operating pressure of 15 MPa to 20 MPa, for example, lamps of 23 MPa or more or 25 MPa or more), it is desirable in practical use to provide the heating means (heating wire) 10 so as to control the temperature of the luminous bulb 1 positively to suppress blackening. In other words, in the case of mass production of lamps, there is inevitably a variation in the characteristics of the lamps. Therefore, even if the operating pressure of the lamp is about 23 MPa, one or a few lamps may be blackened, and in order to ensure prevention of blackening, it is preferable to provide the heating means (heating wire) 10 in the lamps having an operating pressure exceeding the conventional operation pressure of 15 MPa to 20 MPa. The effect of blackening is larger as the operating pressure is larger, in other words, the effect of blackening is larger in a lamp of 40 MPa than in a lamp of 30 MPa, and therefore it is needless to say that the technical significance of blackening suppression by the heating means (heating wire) 10 is larger as the operating pressure is larger.

Next, the results of measuring the temperature of the lamps 100 and 200 using a radiation thermometer will be described. After measuring the temperature of the lamps 100, the heating wire 10 was wound around the sealing portion 2 of the lamp 100 and thus the lamp 200 was produced and the lamp 200 was operated in the manner as shown in FIG. 7. In other words, the lamps 200 and 100 are the same lamps except one difference of whether or not the heating wire 10 is provided.

The temperatures of the lamps 100 and 200 were measured 30 minutes after the operation, and for each lamp, the temperatures in three portion, that is, the upper outer surface of the luminous bulb (A in FIG. 7), the lower outer surface thereof (B in FIG. 7), and the side portion thereof (C in FIG. 7) were measured.

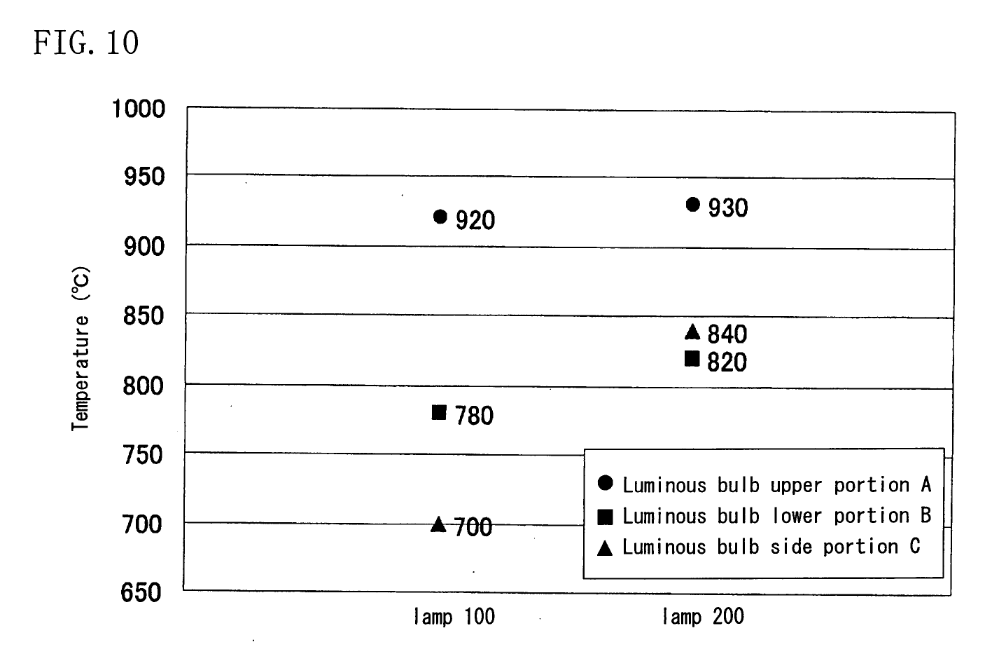

FIG. 10 shows the measurement results. In the case of the lamp 100, the temperature in the upper portion A was 920° C., the temperature in the lower portion B was 780° C. and the temperature in the side portion C was 700° C. On the other hand, in the case of the lamp 200, the temperature in the upper portion A was 930° C., the temperature in the lower portion B was 820° C. and the temperature in the side portion C was 840° C. This means that the temperature was increased by 10° C. in the upper portion of the luminous bulb 1, 40° C. in the lower portion of the luminous bulb 1 and 140° C. in the side portion of the luminous bulb 1 by heating the lamp with the heating means 10. Thus, the temperature distribution of the luminous bulb 1 is changed by configuring a lamp so as to have means for heating the lamp, and thus the temperature condition in which blackening does not occur was created intentionally.

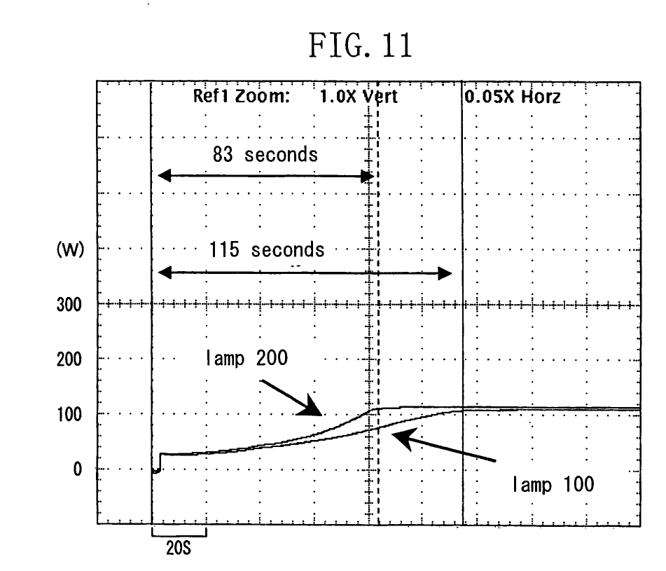

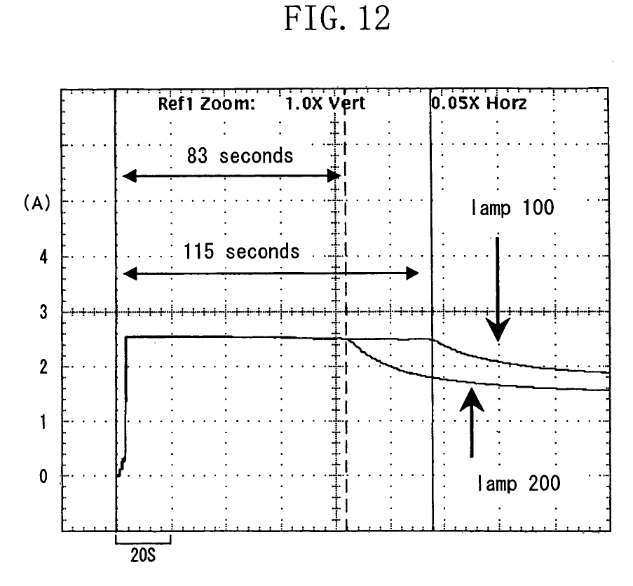

Furthermore, the power and the current after the start of the operation of the lamp were measured. FIGS. 11 and 12 show a change in the power and the current over time, respectively.

The vertical axis of FIG. 11 indicates power, and one scale represents 100 W The horizontal axis shows time, and one scale represents 20 seconds. As seen from FIG. 11, the power is increased gradually immediately after the start of the operation of the lamps, and when the power reached an operating power of 120 W at a certain time and then became constant. The time was 115 seconds for the lamp 100 and 83 seconds for the lamp 200. In other words, heating the luminous bulb advanced the time at which the power reached the operating power by about 30 seconds or more. The magnitude of the power is reflected on the luminous flux and the time at which the luminous flux rises is also advanced by about 30 seconds, and the structure of the lamp 200 has an effect of reducing the luminous flux rise time.

The vertical axis of FIG. 12 indicates current, and one scale represents 1A. The horizontal axis shows time, and one scale represents 20 seconds. Since Hg evaporates only in a small amount immediately after the start of the operation of the lamp, the voltage is very small, as seen from FIG. 12. Therefore, a large current flows, but in order to reduce a load to the electrodes, the current value that flows in this early stage is limited by the ballast. This is referred to as a “limited current”.

After the start of the operation, the limited current flows for a while, and when Hg evaporates sufficiently, the voltage is increased, and the current value begins to be decreased at a certain time. As the time during which the limited current flow is shorter, the load to the electrodes is smaller, and a lamp having a long lifetime can be provided. When the current value is measured, the time during which the limited current was 115 seconds for the lamp 100 and 83 seconds for the lamp 200. The time is about 30 seconds shorter in the lamp 200. This means that the lamp 200 of this embodiment has a smaller load to the elements and has a structure that is effective to prolong the lifetime.

The high pressure mercury lamp of this embodiment is provided with the heating means (heating wire) 10 for heating the luminous bulb 1, so that even if the amount of enclosed mercury is 230 mg/cm³ or more (e.g., 300 mg/cm³ or more), blackening can be suppressed.

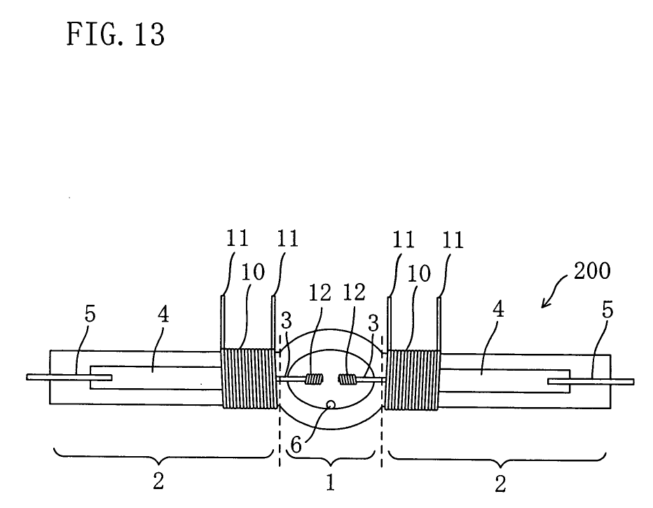

In the structure of this embodiment, the heating wire 10 is wound around the sealing portions 2 on both sides, straddling the luminous bulb 1, but as shown in FIG. 13, the heating wire 10 may be wound separately each of the pair of sealing portions 2. Alternatively, the heating wire 10 may be wound around only one of the sealing portions 2. When the heating wire 10 is wound around only one of the sealing portions 2, it is possible to adjust the temperature by providing a heat reserving film in the other sealing portion 2. Furthermore, the heating wire 10 can be wound around the sealing portions 2 such a manner that a portion of the luminous bulb 1 is also covered.

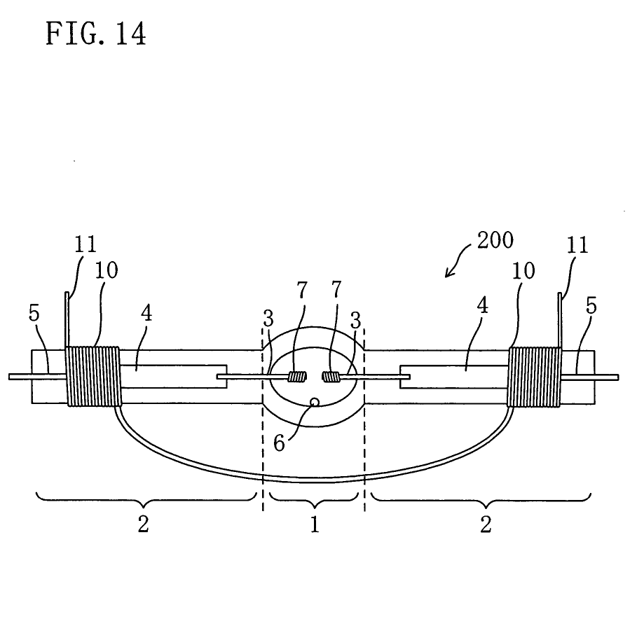

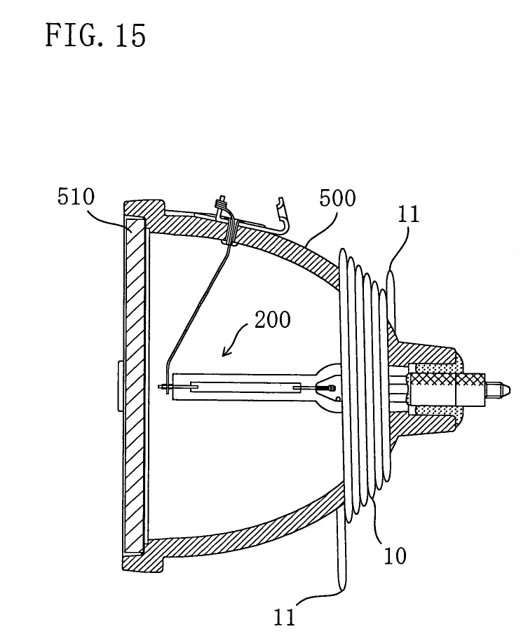

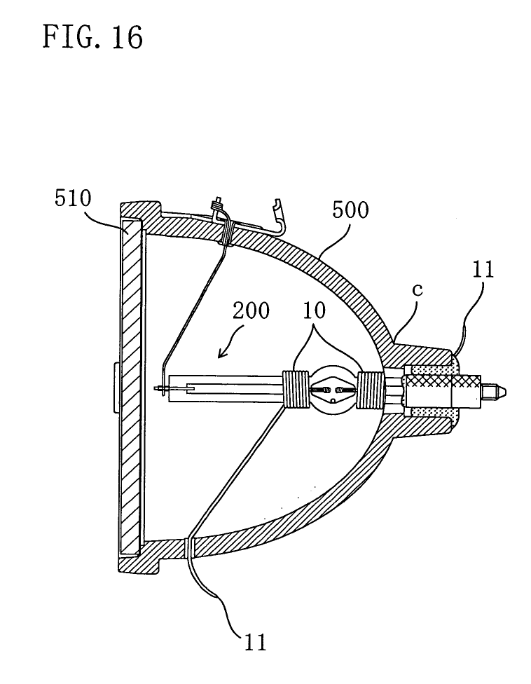

In the lamp of this embodiment, a kanthal wire, which is hardly oxidized, is used as the heating wire, but other heating wires such as a nichrome wire may be used. Although all the description is based on the heating wire as the heating means, the present invention is not limited thereto, and other heating means such as a halogen heater or a high frequency induction heating apparatus can be used. The portion to be heated is typically a position including the outer circumference of a portion of the sealing portion 2 in which the electrode 3 is buried (position of the sealing portion 2 on the side of the luminous bulb 1), as shown in FIG. 6B, but the present invention is not limited thereto and any position can be used, as long as the temperature of the luminous bulb 1 is controlled to suppress blackening. For example, as shown in FIG. 14, the position may be a position including the outer circumference of a portion of the sealing portion 2 in which the external lead wire 5 is buried (position of the sealing portion 2 on the side of the external lead wire 5). Alternatively, as shown in FIG. 15, when the high pressure mercury lamp 200 is combined with a mirror (reflecting mirror) 500 so as to constitute a lamp unit (or a lamp provided with a mirror), the heating wire (heating means) 10 can be wound around the mirror. The heating means 10 may be arranged in a portion of a lamp system in which a lamp or a lamp unit is incorporated. In other words, if it is possible to prevent blackening by intentionally changing the temperature of the luminous bulb 1, those skilled in the art can arrange the heating means or the portion to be heated. It is preferable that a front glass 510 is provided in a front opening portion of the mirror 500 of a lamp unit for airtightness, as shown in FIGS. 15 and 16, for the unlikely event that the high pressure mercury lamp 200 is broken. However, if countermeasures for safety are taken, a non-airtightness type mirror can be used. It is possible to integrate the power unit 22 and the ballast 32 into one piece in order to reduce the size of the apparatus.

Embodiment 2

Next, Embodiment 2 will be described. The structure of this embodiment is obtained by further adding a temperature control function to the structure of Embodiment 1.

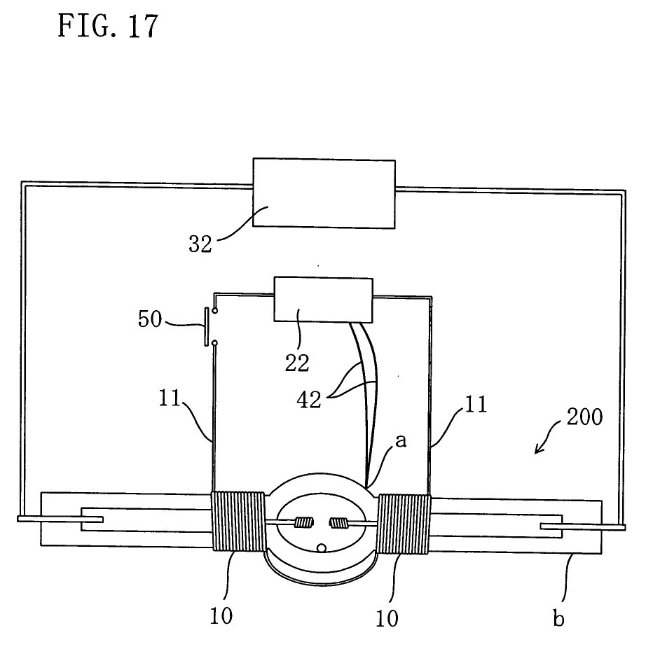

For example, if a thermocouple 40 is attached to a portion a of the lamp 200 as shown in FIG. 17, the function to control the temperature can be added. If the temperature measuring means (40) is provided in this manner, the temperature can be controlled more precisely.

In this embodiment, a measuring system for measuring the temperature is incorporated in the power unit 22, and is configured so as to control as follows. When the measured temperature is lower than the defined temperature, a switch 50 is turned on to flow current through the heating wire 10, whereas when the measured temperature is higher than the defined temperature, the switch 50 is turned off. When the switch 50 is off, the heating wire 10 functions as a radiation wire and therefore has an effect of reducing the temperature. Therefore, the temperature can be adjusted smoothly.

The temperature measurement is not necessarily performed with the thermocouple, and infrared radiation can be measured. Instead of the portion a in FIG. 17, the sealing portion of the lamp (e.g., b in FIG. 17) or a portion of the mirror (e.g., c in FIG. 16) can be used for the measurement, or a portion of the lamp system in which the lamp or the lamp unit is incorporated can be used for measurement. That is, any suitable temperature measuring means and portions for measurement can be used, as long as the structure can measure the temperature and control the temperature of the luminous bulb to be constant.

Embodiment 3

Next, Embodiment 3 will be described. The structure of this embodiment is obtained by further adding a start-up aid function to the structure of Embodiment 1.

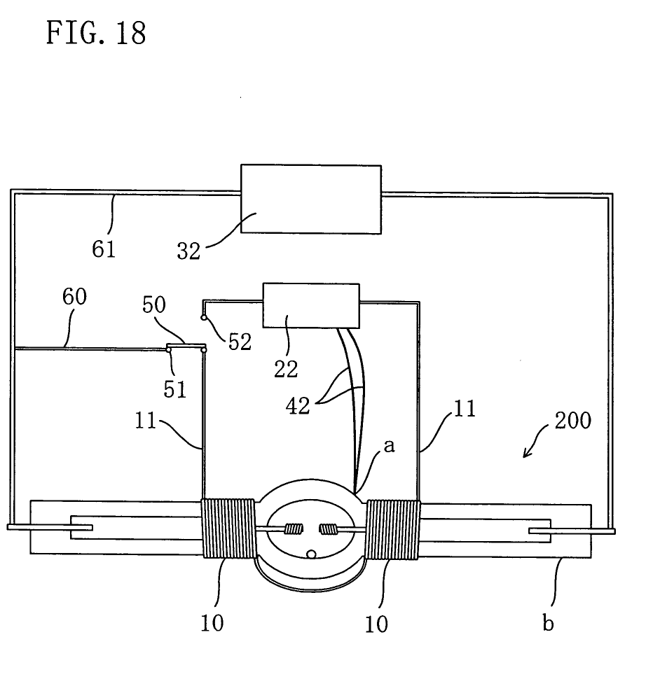

For example, as shown in FIG. 18, an end 11 extending from the heating wire 10 of the lamp 200 is connected to a conductor 60 that is branched from a conductor 61 electrically connected to the ballast 32 via a switch 50 so that the start-up voltage of the lamp 200 can be decreased.

Next, the operation principle of this lamp 200 will be described. First, before operating the lamp 200, the switch 50 is connected to a terminal 51. After the start of the operation of the lamp 200, the connection of the switch 50 is switched to a terminal 52, and thus the lamp 200 starts to be heated. When the lamp 200 is operated in this order, the start-up voltage that has been conventionally 5 to 10 kV is reduced to about 1 kV or less in the lamp 200 of this embodiment.

The start-up voltage can be reduced for the following reason. When starting an operation of the lamp 200, a high voltage pulse is applied from the ballast 32. This high voltage pulse is also applied to the heating wire 10 through the conductor 61. That is, the heating wire 10 serves as a start-up aid wire (trigger wire) and can reduce the start-up voltage of the lamp 200.

Embodiments 1 to 3 can be mutually applied. In other words, for example, it is possible to combine the structure of Embodiment 2 and the structure of Embodiment 3, and it is possible to combine a variation example of Embodiment 1 and the structure of Embodiment 2 and/or Embodiment 3. Furthermore, the blackening of the high pressure mercury lamp is a problem that should be avoided in lamps having an operating pressure exceeding 15 MPa to 20 MPa, which is the conventional operating pressure, and therefore the lamp 200 does not have to be the lamps 1100 to 1500 shown in FIGS. 2 to 5 and can be any lamp, as long as it has an operating pressure of more than 20 MPa (e.g., lamps of 23 MPa or more, in particular, 30 MPa or more) and excellent high withstand pressure characteristics.

Also, the blackening of Embodiments 1 to 3 is affected by the relationship between the halogen density and the temperature of the luminous bulb, and therefore, for example, when CH₂Br₂ is selected as halogen to be enclosed, it is preferable to enclose it in an amount of about 0.0017 to 0.17 mg/cc based on the internal volume of the luminous bulb. If this preferable amount is represented based on the halogen atom density, it is about 0.01 to 1 μmol/cc. This is because if the amount is less than 0.01 μmol/cc, the major part of the halogen reacts with impurities in the lamp, which substantially prevents the halogen cycle from occurring. If the amount is more than 1 μmol/cc, a pulse voltage necessary for startup becomes higher and this is not practical. However, when a ballast that can apply a high voltage is used, this limitation is not applied. It is more preferable that the amount of 0.1 to 0.2 μmol/cc, because even if there is more or less a variation in the amount of the enclosed halogen due to various situations during production, the halogen cycle can work well in this range.

In the lamps of Embodiments 1 to 3, if the bulb wall load is 80 W/cm² or more, the temperature of the bulb wall of the luminous bulb is increased sufficiently, so that all the enclosed mercury evaporates, and therefore the following approximate expression is satisfied: the amount of mercury per internal volume in the luminous bulb: 400 mg/cc=the operating pressure during operation: 40 MPa. Here, if the amount of mercury is 300 mg/cc, the operating pressure is 30 MPa during operation. On the other hand, if the bulb wall load is less than 80 W/cm², the temperature of the luminous bulb cannot be increased sufficiently to evaporate the mercury, and therefore the approximate expression may not be satisfied. In the case of less than 80 W/cm², a desired operating pressure often cannot be obtained, and in particular, light emission in the infrared region is small, and the lamp is not suitable as a light source for projectors.

An image projecting apparatus can be configured by combining the high pressure mercury lamp of the above-described embodiments or the lamp unit (lamps provided with a reflecting mirror) and an optical system including a picture element (such as DMD (Digital Micromirror Device) panel or a liquid crystal panel). For example, a projector using DMD (digital light processing (DLP) projector) and a liquid crystal projector (including a reflecting projector employing an LCOS (Liquid Crystal on Silicon) structure) can be provided. Furthermore, the lamp of the embodiments of the present invention can be used preferably, not only as a light source of an image projecting apparatus, but also for other applications, such as a light source for ultraviolet ray steppers or a light source for sport stadium, a light source for automobile headlights, and a floodlight for illuminating traffic signs.

In the above-described embodiments, the mercury lamp employing mercury as the luminous material is used as an example of a high pressure discharge lamp, but the present invention can be applied to a metal halide lamp having a structure in which the sealing portions (seal portions) retain the airtightness in the luminous bulb. A metal halide lamp is a high pressure mercury lamp in which a metal halide is enclosed. This is because also in the metal halide lamps, it is preferable in terms of the reliability to configure a structure in which the withstand pressure is improved, and the amount of the metal halide evaporated can be changed and the light emission efficiency and the optical spectrum can be controlled by controlling the temperature of the luminous bulb (1) with the heating means (10). In recent years, mercury free metal halide lamps in which mercury is not enclosed have been under development, and this also applies to those mercury free metal halide lamps.

An example of the mercury free metal halide lamps is as follows: in the structure shown in FIG. 6B and other drawings, mercury is substantially not enclosed in the luminous bulb 1, and at least a first halogenide, a second halogenide and rare gas are enclosed. The metal of the first halogenide is a luminous material, and the second halogenide has a vapor pressure higher than that of the first halogenide, and is a halogenide of one or more metals that emit light in a visible light region with more difficulty than the metal of the first halogenide. For example, the first halogenide is a halogenide of one or more metals selected from the group consisting of sodium, scandium, and rare earth metals. The second halogenide has a relatively larger vapor pressure and is a halogenide of one or more metals that emit light in a visible light region with more difficulty than the metal of the first halogenide. More specifically, the second halogenide is a halogenide of at least one metal selected from the group consisting of Mg, Fe, Co, Cr, Zn, Ni, Mn, Al, Sb, Be, Re, Ga, Ti, Zr, and Hf. The second halogenide containing at least a halogenide of Zn is more preferable.

Another combination example is as follows. In a mercury-free metal halide lamp including a translucent luminous bulb (airtight vessel) 1, a pair of electrodes 3 provided in the luminous bulb 1, and a pair of sealing portions 2 coupled to the luminous bulb 1, ScI₃ (scandium iodide) and NaI (sodium iodide) as luminous materials, InI₃ (indium iodide) and TlI (thallium iodide) as alternative materials to mercury, and rare gas (e.g., Xe gas at 1.4 MPa) as starting aid gas are enclosed in the luminous bulb 1. In this case, the first halogenide is constituted by ScI₃ (scandium iodide) and NaI (sodium iodide), and the second halogenide is constituted by InI₃ (indium iodide) and TlI (thallium iodide). The second halogenide can be any halogenide, as long as it has a comparatively high vapor pressure and can serve as an alternative to mercury, and therefore, for example, an iodide of Zn can be used, instead of InI₃ (indium iodide) and the like.

The present invention has been described by way of preferable embodiments, but the above-description is not limiting and various modifications can be made.

Although the structure is different from that of the lamp of this embodiment, the lamp disclosed in Japanese Laid-Open Patent Publication No. 2001-266797 is an example of the technique using means for heating the luminous bulb.

The lamp disclosed in this publication is a lamp that is operated with direct current with a feature of heating the lamp before operation in order to prevent glow discharge that occurs at the time of the start-up. This lamp is directed to heating the lamp before operation, and after the operation, heating is stopped, which is clearly described. In addition, this lamp does not control the temperature of the luminous bulb during operation. In fact, when no current flows through the heating wire after the operation, in the lamp having an operating pressure of 30 MPa or more, the side tube portion is broken at the portion around which the heating wire is wound. This seems to be because the heating wire constantly serves as a radiation wire and the balance of the stress in that portion collapses so that crakes are generated. In other words, the glass tends to expand with an increase of the temperature during operation, but when it is forcefully cooled from the outside, an opposite force for contraction works from the outer surface. Therefore, the glass is broken. In particular, at an operating pressure of 30 MPa or more, the stress applied to the luminous bulb is large so that this effect appears significantly.

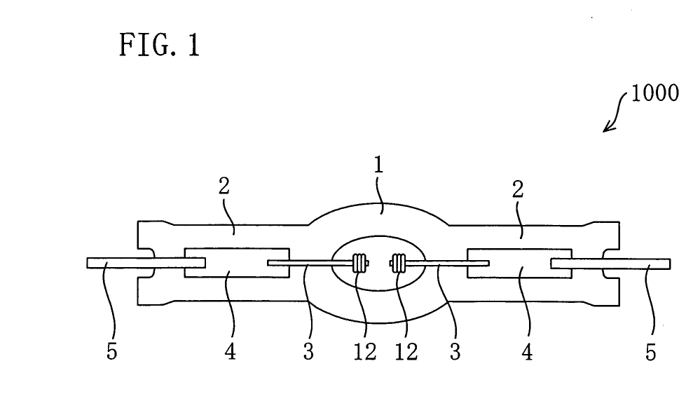

Regarding the lamp (see FIG. 1) disclosed in Japanese Laid-Open Patent Publication No. 2-148561, its publication describes that the Hg vapor pressures is 200 bar to 350 bar (corresponding to about 20 MPa to about 35 MPa). However, the examination of the inventors of the present invention made it clear that when this lamp is operated at an operating pressure of 30 MPa or more, the lamp is broken in a probability of several tens % or more in the first six hours of operation. It is predicted that during operation of 2000 hours, which is required for practical use, more lamps will be broken, and it is difficult in reality to achieve the operating pressure of 30 MPa or more in the practical level in the lamp having the structure shown in FIG. 1.

According to the present invention, even a high pressure mercury lamp having an operating pressure of 20 MPa or more (e.g., 23 MPa or more, in particular 25 MPa or 30 MPa or more) can be operated while blackening can be suppressed.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A high pressure mercury lamp comprising a luminous bulb in which at least mercury is enclosed inside the bulb, and a pair of sealing portions that retain airtightness of the luminous bulb,
wherein at least one of the sealing portions has a first glass portion extending from the luminous bulb and a second glass portion provided in at least a portion inside the first glass portion, and the one of the sealing portions has a portion to which a compressive stress is applied, and
a heating wire is provided at least at part of the luminous bulb and the pair of sealing portions.

2. The high pressure mercury lamp according to claim 1, wherein an amount of the enclosed mercury is 230 mg/cm³ or more based on a volume of the luminous bulb.

3. The high pressure mercury lamp according to claim 1, wherein
an amount of the enclosed mercury is 300 mg/cm³ or more based on a volume of the luminous bulb,
halogen is enclosed in the luminous bulb,
a bulb wall load of the high pressure mercury lamp is 80 W/cm² or more, and
the heating wire is means for heating the luminous bulb.

4. The high pressure mercury lamp according to claim 1, wherein the heating wire is wound around at least one of the sealing portions.

5. The high pressure mercury lamp according to claim 1, wherein
external lead wires are extending from end portions of the pair of sealing portions, and
one end of the heating wire is electrically connected to at least one of the external lead wires.

6. The high pressure mercury lamp according to claim 5, wherein
a switch for turning on and off an electrical connection with the external lead wire is provided in a portion of the heating wire, and
the heating wire is electrically connected to the external lead wire before operation, and after operation, the electrical connection with the external lead wire is disconnected, and the heating wire is electrically connected to a power source for supplying current to the heating wire.

7. The high pressure mercury lamp according to claim 1, wherein
a pair of electrode rods are opposed to each other in the luminous bulb,
at least one of the pair of electrode rods is connected to a metal foil, and
the metal foil is provided in the sealing portion, and at least a portion of the metal foil is positioned in the second glass portion.

8. The high pressure mercury lamp according to claim 7, wherein
a coil having at least one metal selected from the group consisting of Pt, Ir, Rh, Ru, and Re at least on its surface is wound around at least in a portion of the electrode rod that is buried in the at least one of the sealing portions.

9. The high pressure mercury lamp according to claim 1, wherein
a metal portion that is in contact with the second glass portion and supplies power is provided in the sealing portions,
the compressive stress is applied at least in a longitudinal direction of the sealing portions,
the first glass portion contains 99 wt % or more of SiO₂, and
the second glass portion contains SiO₂ and at least one of 15 wt % or less of Al₂O₃ and 4 wt % or less of B.

10. A high pressure mercury lamp comprising a luminous bulb in which at least mercury is enclosed inside the bulb and a pair of electrode rods are opposed, and a pair of sealing portions extending from the luminous bulb, wherein
a coil having at least one metal selected from the group consisting of Pt, Ir, Rh, Ru, and Re at least on its surface is wound around at least in a portion of the electrode rod that is buried in at least one of the sealing portions, and
a heating wire is provided at least at part of the luminous bulb and the pair of sealing portions.

11. A high pressure mercury lamp comprising a luminous bulb in which at least mercury is enclosed inside the bulb, and a pair of sealing portions that retain airtightness of the luminous bulb, wherein
an amount of the enclosed mercury is 230 mg/cm³ or more based on a volume of the luminous bulb, and
heating means for heating the luminous bulb is provided at least at part of the luminous bulb and the pair of sealing portions.

12. The high pressure mercury lamp according to claim 11, wherein
the heating means is a heating wire,
an amount of the enclosed mercury is 300 mg/cm³ or more based on a volume of the luminous bulb,
halogen is enclosed in the luminous bulb, and
a bulb wall load of the high pressure mercury lamp is 80 W/cm² or more.

13. The high pressure mercury lamp according to any one of claims 1, 10 and 11, further comprising means for measuring a temperature of the luminous bulb.

14. The high pressure mercury lamp according to claim 13, wherein the means for measuring the temperature is a thermocouple.

15. The high pressure mercury lamp according to claim 11, wherein the heating means is configured so as to heat the luminous bulb at the same time as operation is started or after operation is started.

16. A lamp unit comprising a high pressure mercury lamp and a reflecting mirror for reflecting light emitted from the high pressure mercury lamp,
the high pressure mercury lamp comprising a luminous bulb in which at least mercury is enclosed inside the bulb, and a pair of sealing portions that retain airtightness of the luminous bulb,
wherein at least one of the sealing portions has a first glass portion extending from the luminous bulb and a second glass portion provided in at least a portion inside the first glass portion, and the one of the sealing portions has a portion to which a compressive stress is applied, and
a heating wire is provided at least at part of the luminous bulb and the pair of sealing portions.

17. A lamp unit comprising a high pressure mercury lamp and a reflecting mirror for reflecting light emitted from the high pressure mercury lamp,
the high pressure mercury lamp comprising a luminous bulb in which at least mercury is enclosed inside the bulb, and a pair of sealing portions that retain airtightness of the luminous bulb,
wherein at least one of the sealing portions has a first glass portion extending from the luminous bulb and a second glass portion provided in at least a portion inside the first glass portion, and the one of the sealing portions has a portion to which a compressive stress is applied, and
a heating wire is provided at least at a portion of the reflecting mirror.

18. The lamp unit according to claim 16 or 17, wherein an amount of the enclosed mercury is 230 mg/cm³ or more based on a volume of the luminous bulb.

19. A lamp unit comprising a high pressure mercury lamp and a reflecting mirror for reflecting light emitted from the high pressure mercury lamp,
the high pressure mercury lamp comprising a luminous bulb in which at least mercury is enclosed inside the bulb, and a pair of sealing portions that retain airtightness of the luminous bulb,
wherein an amount of the enclosed mercury is 230 mg/cm³ or more based on a volume of the luminous bulb, and
heating means for heating the luminous bulb is provided at least at part of the luminous bulb and the pair of sealing portions.

20. The lamp unit according to claim 16 or 17, wherein
an amount of the enclosed mercury is 300 mg/cm³ or more based on a volume of the luminous bulb,
halogen is enclosed in the luminous bulb, and
a bulb wall load of the high pressure mercury lamp is 80 W/cm² or more.

21. The lamp unit according to any one of claims 16, 17 and 19, further comprising means for measuring a temperature of the luminous bulb.

22. The lamp unit according to claim 19, wherein
the heating means is a heating wire, and
the heating wire serves as a trigger wire.
